(19) United States
(12) Patent Application Publication
(10) Pub. No.: US 2016/0304343 A1
(43) Pub. Date: Oct. 20, 2016

(54) SYSTEM AND COMBUSTION REACTION HOLDER CONFIGURED TO TRANSFER HEAT FROM A COMBUSTION REACTION TO A FLUID

(71) Applicant: ClearSign Combustion Corporation, Seattle, WA (US)

(72) Inventors: RICHARD F. RUTKOWSKI, SEATTLE, WA (US); JOSEPH COLANNINO, BELLEVUE, WA (US); DOUGLAS W. KARKOW, DES MOINES, WA (US); ROBERT E. BREIDENTHAL, SEATTLE, WA (US); CHRISTOPHER A. WIKLOF, EVERETT, WA (US)

(21) Appl. No.: 15/098,701

(22) Filed: Apr. 14, 2016

Related U.S. Application Data
(63) Continuation of application No. PCT/US2014/062291, filed on Oct. 24, 2014.
(60) Provisional application No. 61/895,361, filed on Oct. 24, 2013.

(51) Int. Cl. C01B 3/34; F23N 5/02; F23M 9/10; B01J 7/02; F23C 3/00

(52) U.S. Cl. CPC C01B 3/34; B01J 7/02; F23C 3/00; F23M 9/10; F23N 5/022; C01B 2203/0216; C01B 2203/0816; C01B 2203/1241; F23N 2025/04

(57) ABSTRACT

A combustion system includes a combustion reaction holder that defines plurality of combustion channels and a fluid volume separate from the plurality of combustion channels. The combustion channels are collectively configured to hold a combustion reaction. Heat from the combustion reaction is transferred to a fluid disposed in the fluid volume.

### CROSS REFERENCE TO RELATED APPLICATIONS

The present application is a U.S. Continuation Application which claims priority benefit under 35 U.S.C. §120 (pre-AIA) of co-pending International Patent Application No. PCT/US2014/062291, entitled “SYSTEM AND COMBUSTION REACTION HOLDER CONFIGURED TO TRANSFER HEAT FROM A COMBUSTION REACTION TO A FLUID,” filed Oct. 24, 2014 (docket number 2651-183-04); which application claims priority benefit from U.S. Provisional Patent Application No. 61/895,361, entitled “SYSTEM AND METHOD INCLUDING A PERFORATED FLAME HOLDER CONFIGURED TO TRANSFER HEAT FROM A COMBUSTION REACTION TO A WORKING FLUID,” filed Oct. 24, 2013 (docket number 2651-183-02), co-pending at the date of filing; each of which, to the extent not inconsistent with the disclosure herein, is incorporated herein by reference.

### SUMMARY

According to an embodiment, a combustion system includes a fuel nozzle assembly and a combustion reaction holder. The fuel nozzle assembly is configured to output fuel and oxidant to the combustion reaction holder. The combustion reaction holder defines a plurality of elongated apertures, also referred to as flame channels, that are configured to collectively receive the fuel and oxidant at respective input ends, hold a combustion reaction supported by the fuel and oxidant, and output combustion products from respective output ends. Each flame channel is defined by a respective flame channel wall. The flame channel walls can be in the form of a plurality of tubes. Each input end of the plurality of flame channels is open to a furnace volume and is configured to receive the fuel and oxidant through respective first openings defined by a first combustion reaction holder wall (also referred to as “first wall”). Each output end of the plurality of flame channels is open to the furnace volume and is configured to output the combustion products through respective second openings defined by a second combustion reaction holder wall (also referred to as “second wall”). The input end of each flame channel wall is contiguous with the first combustion reaction holder wall and the output end of each flame channel wall is contiguous with the second combustion reaction holder wall peripheral to each flame channel. The first and second combustion reaction holder walls each have a peripheral edge. A jacket wall joins a periphery of the first combustion reaction holder wall to a periphery of the second combustion reaction holder wall. The jacket wall, the first combustion reaction holder wall, the second combustion reaction holder wall, and the plurality of flame channel walls collectively define an interior volume, separate from the furnace volume, configured to hold a fluid. The fluid can include a single phase working fluid (e.g. in a hot water generation system), a phase change fluid (e.g. in a steam generator), or a reacting fluid (e.g. a combination of reactants and products produced in an endothermic reaction that receives heat from the flame channels).

In an embodiment, each flame channel wall includes a tube extends from a respective first opening to a respective second opening. The plurality of tubes are configured to receive the fuel into the tubes via the first opening, to substantially contain a combustion reaction of the fuel within the tubes, to transfer heat generated by the combustion reaction to the fluid in the interior volume, and to output flue gas from the tubes via the second opening.

According to another embodiment, a combustion reaction holder includes a first plurality of flame channels configured to collectively hold a combustion reaction and a second plurality of fluid channels interdigitated with the first plurality of flame channels and configured to carry a fluid selected to receive heat from the combustion reaction. In one embodiment the first plurality of flame channels are defined by respective flame channel walls or tubes and the second plurality of fluid channels are defined by respective fluid channel walls, separate from the fluid channel walls. The flame channel walls and fluid channel walls can be in intimate contact with one another or can be separated by a gap selected to maintain a combustion temperature. In another embodiment the first plurality of flame channels are defined by respective flame channel walls and the second plurality of fluid channels are defined by interstitial spaces between the flame channel walls.

According to embodiments, the combustion reaction holder can include a heating apparatus configured to maintain a combustion temperature in the flame channels. In this case, a majority of heat transferred to the fluid is produced by the combustion reaction. Heat output by the heating apparatus is used to maintain the combustion temperature. For example, the heating apparatus can include an electrical resistance heater.

According to embodiments, the flame channel walls can be formed to provide thermal insulation from the heat-receiving fluid. For example, each flame channel wall can be formed from concentric inner and outer tubes separated by a radiation and/or convective heat transfer volume. In another example, each flame channel wall can include impervious inner and outer surfaces and an insulating interior. In one embodiment, the impervious inner surface can be a ceramic tube such as a mullite tube, the impervious outer surface can be a metal tube such as stainless steel, and the insulating interior can be an aerogel.

According to an embodiment, a method includes receiving a fuel and oxidant mixture into a plurality of tubes defined by a combustion reaction holder, each tube extending from a respective first opening in a first wall of the combustion reaction holder to a respective second opening in a second wall of the combustion reaction holder, sustaining a combustion reaction of the fuel and oxidant mixture substantially within the plurality of tubes, and transferring heat generated by the combustion reaction from the tubes to a fluid in an interior volume of the combustion reaction holder peripheral to the tubes. The interior volume is defined by the first wall, the second wall, the plurality of tubes and a jacket wall operatively coupling the first wall to the second wall.

### BRIEF DESCRIPTION OF THE DRAWINGS

FIG. 1 is a block diagram of a combustion system, according to one embodiment.

FIG. 2A is a sectional view of a combustion reaction holder, according to one embodiment.

FIG. 2B is a top view of the combustion reaction holder of FIG. 2A, according to one embodiment.

FIG. 3 is a top view of a combustion reaction holder, according to one embodiment.

FIG. 4A is a top view of a combustion reaction holder, according to one embodiment.

FIG. 4B is a sectional view of a portion of the combustion reaction holder of FIG. 4A, according to one embodiment.

FIG. 5A is a top view of a combustion reaction holder, according to one embodiment.

FIG. 5B is a sectional view of the combustion reaction holder of FIG. 5A, according to one embodiment.

FIG. 5C is a sectional view of the combustion reaction holder of FIG. 5A, according to one embodiment.

FIG. 6 is a block diagram of a combustion system 600, according to one embodiment.

FIG. 7 is a flow diagram of a process 700 for operating a combustion system, according to one embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

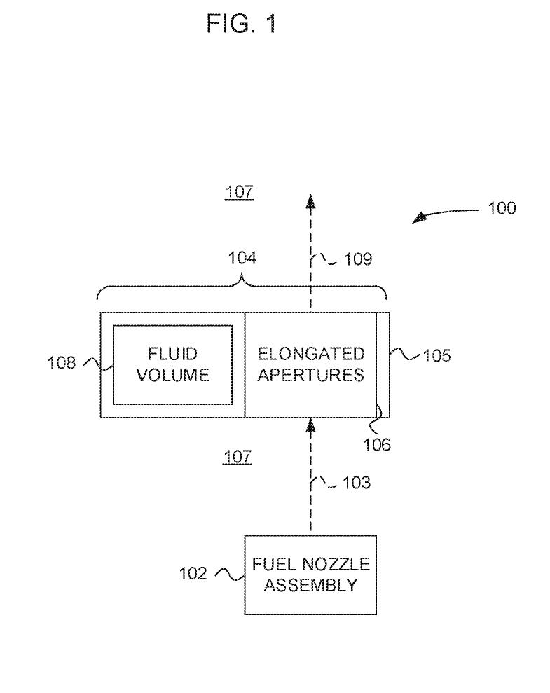

FIG. 1 is a block diagram of a combustion system 100, according to one embodiment. The combustion system 100 includes a fuel nozzle assembly 102 and a combustion reaction holder 104. The combustion reaction holder 104 includes a body 105 defining plurality of elongated apertures 106 open at each end to a furnace volume 107. The combustion reaction holder body 105 further defines a fluid volume 108 positioned adjacent to the plurality of elongated apertures 106 and separated from the furnace volume 107. The fluid volume 108 is also referred to as an interior volume herein.

The fuel nozzle assembly 102 is configured to output a fuel and oxidant mixture 103 to the combustion reaction holder 104. The fuel and oxidant mixture 103 is received into the elongated apertures 106. The combustion reaction holder body 105 outputs heat energy to the received fuel and oxidant mixture 103 sufficient to cause the mixture to ignite. The elongated apertures 106 may substantially contain a combustion reaction of the fuel and oxidant within the elongated apertures 106 and output combustion products 109 to the furnace volume 107. Heat energy from the combustion reaction is output to the combustion reaction holder body 105.

The fluid holding volume 108 is configured to hold a fluid such as a working fluid or a reacting fluid. The fluid can include a liquid, a gas, or a mixture of liquid and gas. The fluid volume 108 and the elongated apertures 106 are positioned such that heat generated by the combustion reaction within the elongated apertures 106 is transferred from the combustion reaction holder body 105 to the fluid in the fluid volume 108. The combustion reaction holder 104 can be configured such that the combustion reaction holder body 105 is impervious to the fluid such that the fluid does not pass from the fluid volume 108 into the elongated apertures 106. The elongated apertures 106 may be referred to as flame channels.

In one embodiment, the combustion system 100 is configured to supply heat from the combustion reaction in the elongated apertures 106 to an endothermic reaction of the fluid.

For embodiments where it is desirable to enhance the transfer of heat from the combustion reaction to the working fluid, the fluid volume 108 and elongated apertures 106 can be configured such that outer walls of the elongated apertures 106 are in direct contact with the fluid in the fluid volume 108. Alternatively, other structures, voids, insulation, and/or air gaps can separate the elongated apertures 106 from the fluid in the fluid volume 108. This can help control the amount of heat that is transferred from the combustion reaction to the working fluid in order to ensure that too much heat is not transferred to the working fluid and/or that the combustion reaction is not quenched by the removal of heat.

In one embodiment, the combustion reaction holder 104 is formed of a ceramic material that can withstand high temperatures without degrading. Alternatively, the combustion reaction holder 104 can be formed of a metal that can withstand high temperatures. The combustion reaction holder 104 can also be made from a combination of materials. For example, a body of the combustion reaction holder 104 that defines the fluid holding volume 108 can include a first material while the elongated apertures 106 include a second material. Those of skill in the art will recognize, in light of the present disclosure, that the combustion reaction holder 104 can be made from a large variety of suitable materials and can include a combination of many materials.

The elongated apertures 106 can include tubes, channels, elongated passageways formed within a material or defined by a body, or any other elongated structure configured to substantially contain a combustion reaction of a fluid. Those of skill in the art will recognize, in light of the present disclosure, that many structures can be used for the elongated apertures 106. All such structures fall within the scope of the present disclosure.

In one example, the combustion system 100 includes a steam methane reformer in which the fluid is a combination of steam and methane reactants; and carbon monoxide, carbon dioxide, and hydrogen products. Steam and methane are introduced as a fluid into the fluid volume 108. The fuel nozzle assembly 102 outputs fuel and oxidant into the elongated apertures 106. For example, the oxidant can be in the form of oxygen carried by combustion air. A combustion reaction of the fuel is substantially contained within the elongated apertures 106. The combustion reaction generates heat that is transferred from the elongated apertures 106 to the steam and methane in the fluid holding volume 108, thereby enabling an endothermic reaction of the steam and the methane that produces hydrogen and carbon monoxide according to the following formula:

CH₄+H₂⇄CO+3H₂

In one embodiment, a subsequent exothermic reaction produces yet more hydrogen from the steam and the carbon monoxide produced by the endothermic reaction. The exothermic reaction produces hydrogen according to the following formula:

CO+H₂O⇄CO₂+H₂

In this way, the combustion reaction holder 104 can be used as a steam methane reformer that produces hydrogen from steam and methane.

In one embodiment, discontinuous packing bodies are positioned in the fluid holding volume 108. The steam and methane fill the gaps between the packing bodies in the fluid holding volume 108. When heated, the packing bodies promote the endothermic reaction between steam and methane when the steam and methane are in contact with the surface of the packing bodies. Therefore, the packing bodies are shaped to have large surface areas relative to the size of the packing bodies to allow for more contact between the steam and methane and the surface of the packing bodies. The discontinuous packing bodies can include ceramic Raschig rings, ceramic Berl saddles, ceramic Intalox saddles, and/or metal rings (e.g. Super Raschig Rings).

While an embodiment has been disclosed in which the combustion system 100 includes a steam methane reformer, those of skill in the art will recognize, in light of the present disclosure, that the combustion system 100 can be used in a large number of applications other than a steam methane reformer. In particular, the combustion system 100 can be used in many other applications in which heat from a combustion reaction is transferred to a working fluid. All such other applications fall within the scope of the present disclosure.

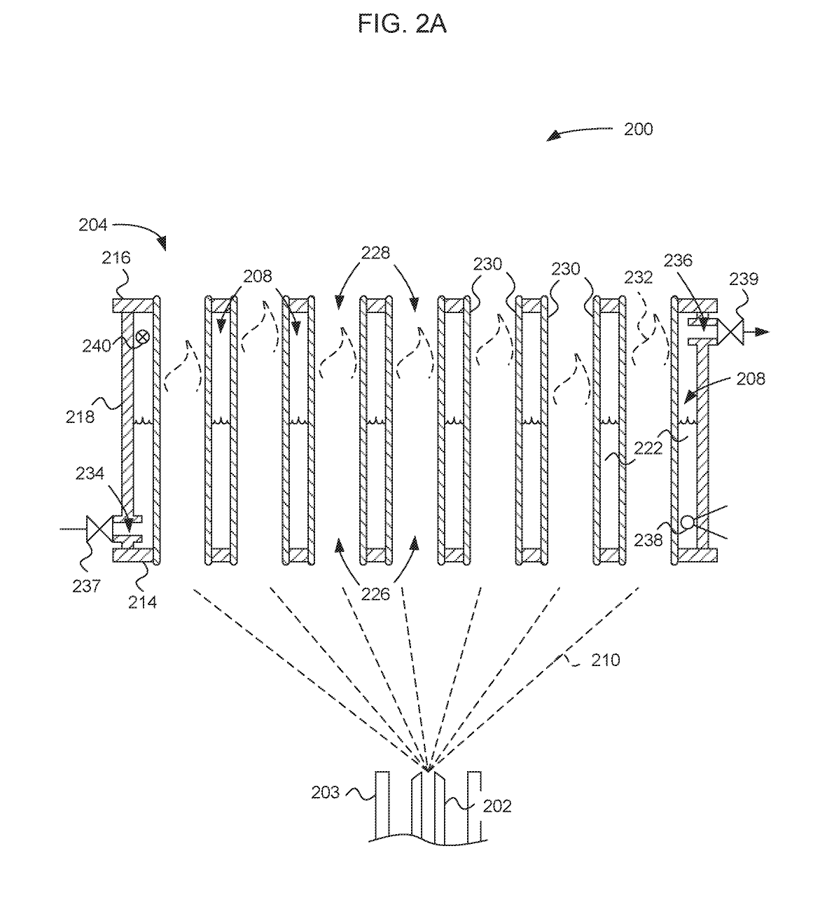

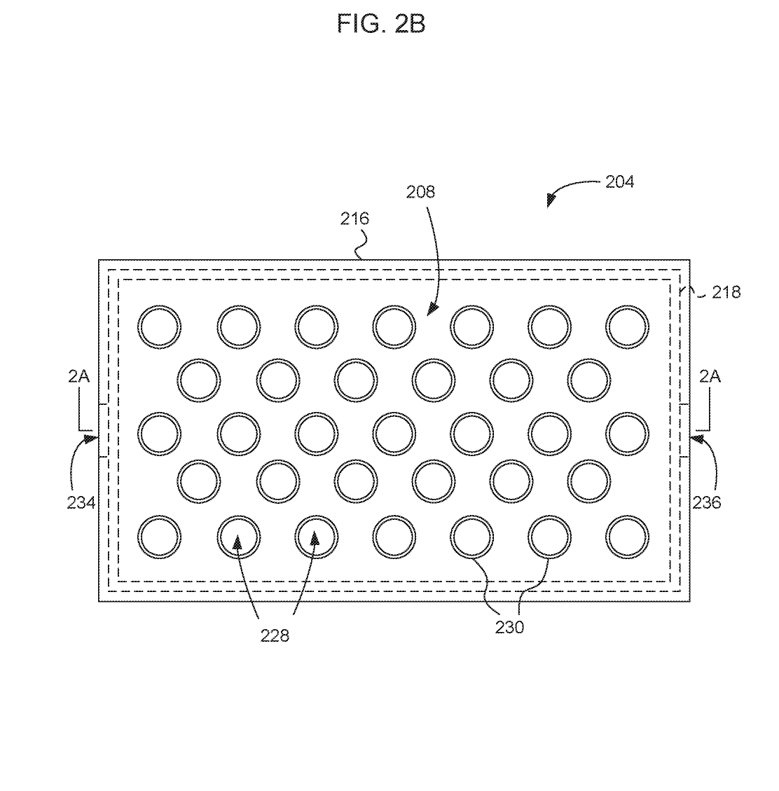

FIG. 2A is a cross-section of a combustion system 200, according to one embodiment. The combustion system 200 includes a fuel nozzle assembly 102 including a fuel nozzle 202, a combustion air source 203, and a combustion reaction holder 204.

The fuel nozzle assembly 102 is configured to output fuel with the fuel nozzle 202, entrain air from the combustion air source 203, and output a fuel and oxidant mixture 210 (diluted by nitrogen and argon from the air) to the combustion reaction holder 204. While a single fuel nozzle assembly 102 is shown in FIG. 2A, in practice multiple fuel nozzle assemblies 102 can be present.

The combustion reaction holder 204 includes a first wall 214 proximate to the fuel nozzle 202, a second wall 216 distal from the fuel nozzle 202, and a jacket wall 218 that operatively couples the first wall 214 to the second wall 216. The first wall 214 includes a plurality of first openings 226. The second wall 216 includes a plurality of second openings 228. A plurality of tubes 230 extends from the first openings 226 to the second openings 228. The first wall 214, the second wall 216, and the jacket 218, form a casing that, in combination with the plurality of tubes 230, defines an interior volume 208 configured to hold a fluid 222 within the combustion reaction holder 204. The interior volume 208 can be a continuous volume surrounding each of the tubes 230.

The tubes 230 can be joined to the walls 214, 216 in a manner that maintains a fluid tight seal through which the working fluid 222 cannot pass. For example, the tubes 230 can be joined to the first and second walls 214, 216 by welding or by high temperature brazing.

The jacket 218 includes an inlet 234 through which the working fluid 222 can be received into the fluid volume 208. The jacket 218 further includes an outlet 236 through which the working fluid 222, or product of the working fluid 222, can pass from the interior volume 208. An inlet valve 237 controls the flow of the working fluid 222 through the inlet 234. An outlet valve 239 controls the flow of the working fluid 222, or the product of the working fluid 222, through the outlet 236.

During operation of the combustion system 200, the fuel nozzle assembly 102 outputs the fuel and oxidant mixture 210 to the combustion reaction holder 104. The fuel and oxidant mixture 210 passes through the first openings 226 into the tubes 230. Heat from the tubes 230 is transferred to the cool, incoming fuel and oxidant mixture 210. A combustion reaction 232 of the fuel and oxidant mixture 210 takes place within the tubes 230. Heat from the combustion reaction 232 is transferred to the tubes 230. The tubes 230 can be configured to substantially contain the combustion reaction 232 of the fuel and oxidant mixture 210 within the tubes 230. Flue gas (including combustion products) is passed from the tubes 230 via the second openings 228.

The walls of the tubes 230 absorb heat generated by the combustion reaction 232. Heat generated by the combustion reaction 232 is transferred from the walls of the tubes 230 to the fluid 222. In this manner the fluid 222 receives heat from the combustion reaction 232 via the walls of the tubes 230.

In one embodiment, the heat transferred from the combustion reaction 232 to the fluid 222 promotes an endothermic reaction of the fluid 222. In another embodiment, the fluid 222 is a working fluid selected to convey heat energy from the combustion reaction 232. A product of the endothermic reaction and/or the fluid 222 can be passed from the interior volume 208 via the outlet 236. While the working fluid 222 is depicted as a liquid in FIG. 2A, in practice the working fluid 222 can be a liquid, a gas, or combination of liquid and gas.

In one embodiment, the combustion system 200 is a steam methane reformer. The working fluid 222 includes steam and methane passed into the interior volume 208 via the inlet 234. Heat from the combustion reaction 232 contained within the tubes 230 is transferred from the tubes 230 to the working methane and steam in the interior volume 208. The heat from the combustion reaction 232 causes an endothermic reaction between the steam and the methane. The reaction between the steam and the methane produces hydrogen and carbon monoxide as described previously. The hydrogen is passed from the interior volume 208 via the outlet 236.

In one embodiment, discontinuous packing bodies are positioned in the interior volume 208. The steam and methane fill gaps between the packing bodies in the interior volume 208. The packing bodies promote the reaction between the steam and methane when the steam and methane are in contact with the surface of the packing bodies. The packing bodies are shaped to have large surface areas relative to the volume of the packing bodies to allow for more contact between the steam and methane and the surface of the packing bodies. The discontinuous packing bodies can include ceramic Raschig rings, ceramic Berl saddles, ceramic Intalox saddles, and/or metal rings (e.g. Super Raschig Rings).

While an embodiment has been disclosed in which the combustion system 200 includes a steam methane reformer, those of skill in the art will recognize, in light of the present disclosure, that the combustion system 200 can be used in a large number of applications in which heat from a combustion reaction 232 is transferred to a working fluid 222. All such other applications fall within the scope of the present disclosure.

In one embodiment, temperature and duration of the reaction within the tubes 230 can be controlled to a value that reduces the formation of oxides of nitrogen or other unwanted particles. In another embodiment, the fluid 222 can be a heated working fluid having a temperature and flow rate selected to cause transfer of heat to the tubes 230. This can be used to maintain the temperature of the tubes and ensure that a majority of the combustion reaction takes place within the tubes.

The walls 214, 216, and the jacket 218 of the combustion reaction holder 204 can be made from materials that maintain their integrity in high temperature environments. For example, the walls 214, 216, and the jacket 218 can be made from a ceramic material, fuse quartz, a metal such as steel or a nickel-iron super alloy, or other materials suitable for use in high temperature environments.

The tubes 230 are likewise made from a material suitable for use in a high temperature environment. For example, the tubes 230 can be made from a ceramic material, fuse quartz, a metal such as steel or a nickel-iron super alloy, or other materials suitable for use in high temperature environments. Those of skill in the art will understand, in light of the present disclosure, that there are many materials that can be suitable for the combustion reaction holder 204. All such other materials fall within the scope of the present disclosure.

In FIG. 2A the walls 214, 216, and the jacket 218 are shown as separate structures coupled together to form a casing that defines the interior volume 208. However, the first wall 214 and the jacket 218 can be an integral body. Alternatively, the second wall 216 and the jacket 218 can be an integral body. Likewise, the walls 214, 216 and the jacket 218 can be an integral body.

In one embodiment, a temperature sensor 238 and a pressure sensor 240 are positioned in the interior volume 208 and configured to measure the temperature and pressure of the working fluid within the interior volume 208. The temperature sensor 238 can include thermistor, a temperature sensitive resistor, a thermocouple or any other suitable temperature sensing device. The pressure sensor can include a MEMS pressure sensor, a mechanical gauge, or any other suitable pressure sensing device.

In one embodiment, the combustion system 200 includes a control circuit coupled to the temperature sensor 238 and the pressure sensor 240. The control circuit can be further coupled to the fuel nozzle 202, to the inlet valve 237, and to the outlet valve 239. The temperature sensor 238 can pass a temperature signal to the control circuit indicating the temperature of the working fluid 222 within the interior volume 208. The pressure sensor 240 can pass a pressure signal to the control circuit indicating pressure of the working fluid within the interior volume 208. Based on the temperature and/or the pressure, the control circuit can adjust the output of the fuel 210 from the fuel nozzle 202 to increase or decrease the amount of heat transferred to the working fluid 222 from the combustion reaction 232 within the tubes 230. For example, the control circuit can adjust the outputting of the fuel 210 by adjusting a distance of the fuel nozzle 202 from the combustion reaction holder 204, by adjusting an amount of oxygen/air mixed with the fuel, or by adjusting a flow rate or velocity of the fuel or oxygen/air from the fuel nozzle 202. The control circuit can also control the inlet valve 237 and the outlet valve 239 to alter the flow of the working fluid 222 into and out of the interior volume 208.

FIG. 2B is a top view of the combustion reaction holder 204 from FIG. 2A, according to one embodiment. The top view shows the wall 216 of the combustion reaction holder 204, the second openings 228 in the wall 216, and the tops of the tubes 230 in the openings 228. Additionally, the jacket 218 is shown in dashed lines indicating that it is below the wall 216. The jacket 218, together with the walls 214, 216 enclose the interior volume 208 within the combustion reaction holder 204.

The top view of the combustion reaction holder 204 in FIG. 2B more clearly illustrates the arrangement of the tubes 230. In the example of FIG. 2B, the tubes 230 are arranged in five rows in an offset pattern with respect to each other. The separation between the tubes 230 illustrates that the interior volume 208 is a continuous volume that surrounds the tubes 230.

The tubes 230 can also be arranged in patterns other than that shown in FIG. 2B. For example, the tubes 230 can be arranged in one or more arrays such as a square array, a close-packed hexagonal array, or in groups disposed equidistantly along one or more concentric rings, or some combination thereof. Those of skill in the art will recognize, in light of the present disclosure, that many other patterns and arrangements for the tubes 230 are possible. All such other patterns and arrangements fall within the scope of the present disclosure.

In FIG. 2B the tubes 230 have a circular cross-section. However, the tubes 230 can have a cross-section other than circular. For example, the tubes 230 can have a square cross-section, an elliptical cross-section, a hexagonal cross-section, a cross-section including laterally protruding arms, or any other suitable cross-section. Furthermore, the tubes 230 can have the shape of a tapered cylinder, a hollow stepped or tapered cylinder, and/or a shape having a vertical portion and a tapered portion. The tubes 230 can be substantially identical in diameter to one another or can be formed to have a plurality of different diameters

The combustion reaction holder 204 of FIG. 2B has a rectangular shape. However, other shapes are possible for the combustion reaction holder 204. For example, the combustion reaction holder 204 can be circular from a top view. Alternatively combustion reaction holder 204 can have any other suitable shape.

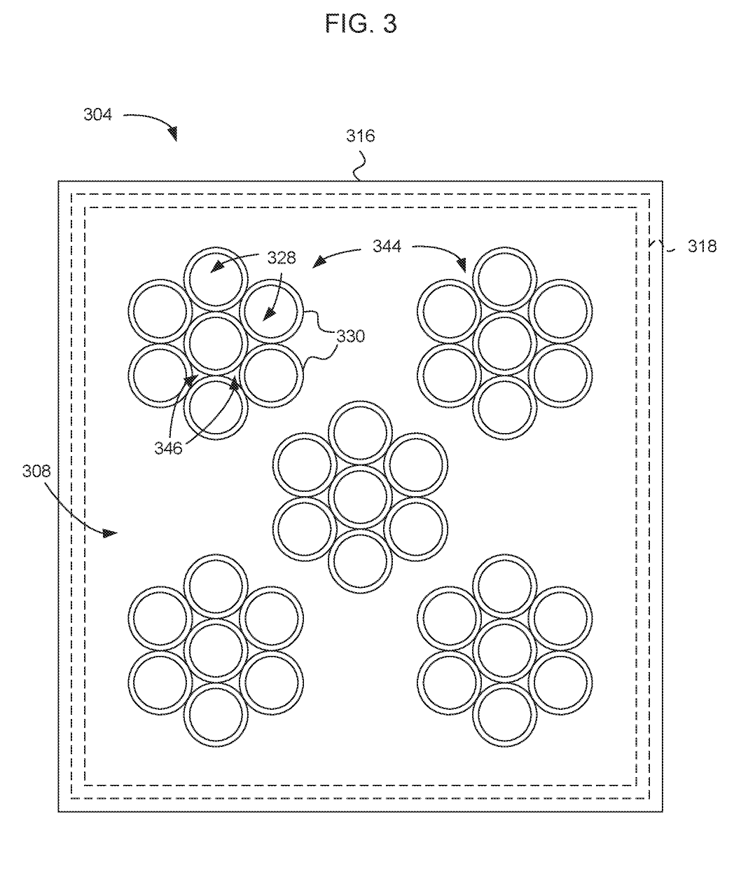

FIG. 3 is a top view of a combustion reaction holder 304 according to one embodiment. The combustion reaction holder 304 is similar in many regards to the combustion reaction holder 204 of FIGS. 2A, 2B. The combustion reaction holder 304 includes a wall 316 having a plurality of openings 328 therein. Tubes 330 are positioned in the openings 328. The tubes 330 are configured to substantially contain a combustion reaction of a fuel. An interior volume 308 is positioned within the combustion reaction holder 304 and defined by the wall 316, a jacket 318, and a further wall below the jacket 318. The interior volume 308 below the wall 316 is configured to hold a working fluid.

The tubes 330 are arranged in groups 344. Each group 344 includes a central tube surrounded by a plurality of peripheral tubes. In one embodiment, the peripheral tubes form a fluid tight ring around the central tube, thereby defining hollow gaps 346 between the central tube and the peripheral tubes. The working fluid does not enter the gaps 346.

In the arrangement of FIG. 3 the central tube of each group 344 transfers heat to the peripheral tubes, but not directly to the working fluid. The central tube serves to transfer heat to the peripheral tubes in order to maintain a high temperature in the peripheral tubes. The peripheral tubes transfer heat to the working fluid.

In one embodiment, the gaps 346 are filled with air. Alternatively, the hollow gaps can be a vacuum.

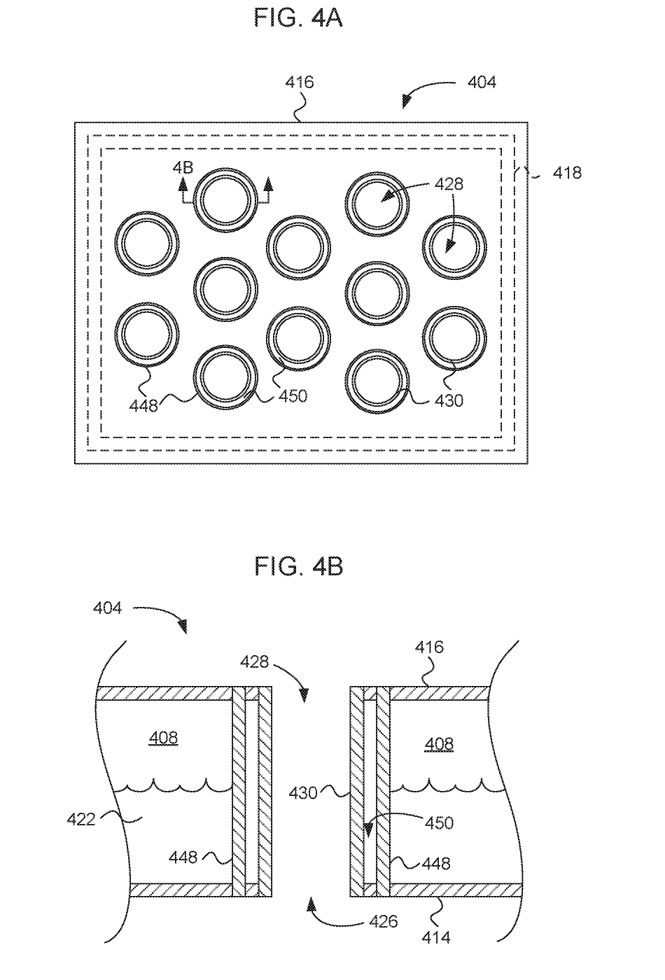

FIG. 4A is a top view of a combustion reaction holder 404, according to one embodiment. The combustion reaction holder 404 is similar in many regards to the combustion reaction holder 204 of FIGS. 2A, 2B. The combustion reaction holder 404 includes a wall 416 having a plurality of openings 428 therein, a wall 414 (see FIG. 4B) having a plurality of openings 426 therein, and a jacket coupling the wall 414 to the wall 416. Tubes 430 are positioned in the openings 428. The tubes 430 are configured to substantially contain a combustion reaction of a fuel. An interior volume 408 (see FIG. 4B) is positioned within the combustion reaction holder 404 and defined by the wall 416, a jacket 418, and a further wall below the jacket 418. The interior volume 408 is configured to hold a working fluid 422 (see FIG. 4B).

The combustion reaction holder 404 further includes a plurality of sheaths 448 each surrounding a respective tube 430. The sheaths 448 separate the tubes 430 from the working fluid 422 in the interior volume 408. An insulating gap 450 is positioned between the tubes 430 and the sheaths 448. The protective sheaths 448 can reduce the amount of heat transferred from the combustion reaction within the tubes 430 to the working fluid 422. In an application in which the combustion reaction outputs more heat than is desirable for the working fluid 422, it can be beneficial to insulate the tubes 430 from the working fluid 422.

The sheaths 448 can be made from a material suitable for high temperature environments such as fused quartz, ceramic material, a metal such as steel, a nickel-iron super alloy, or any other suitable material.

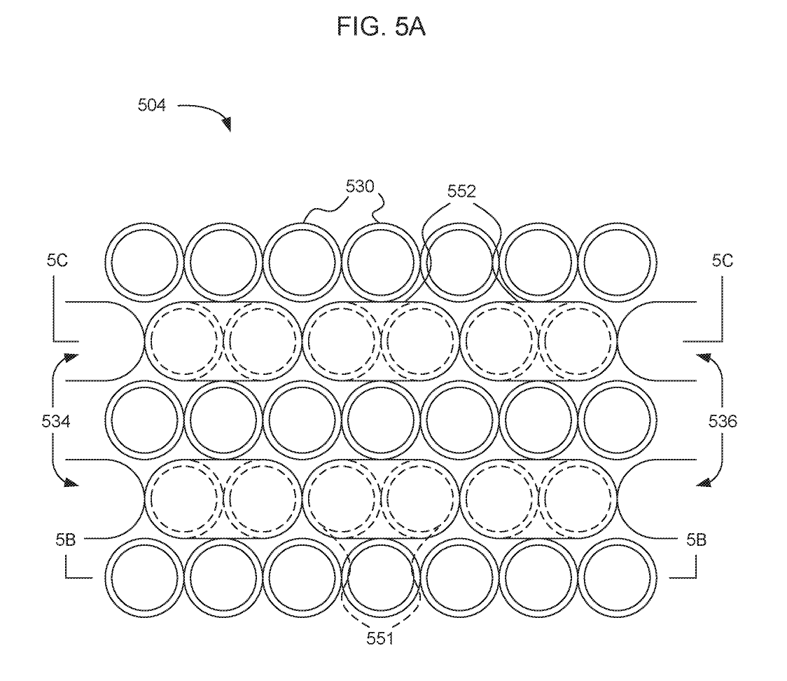

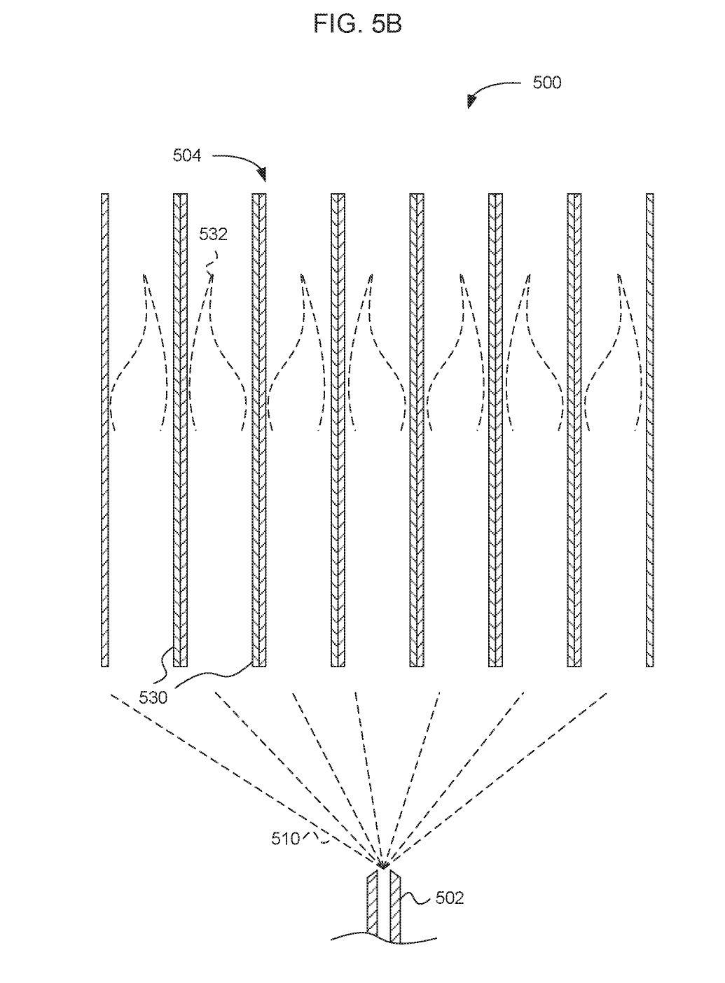

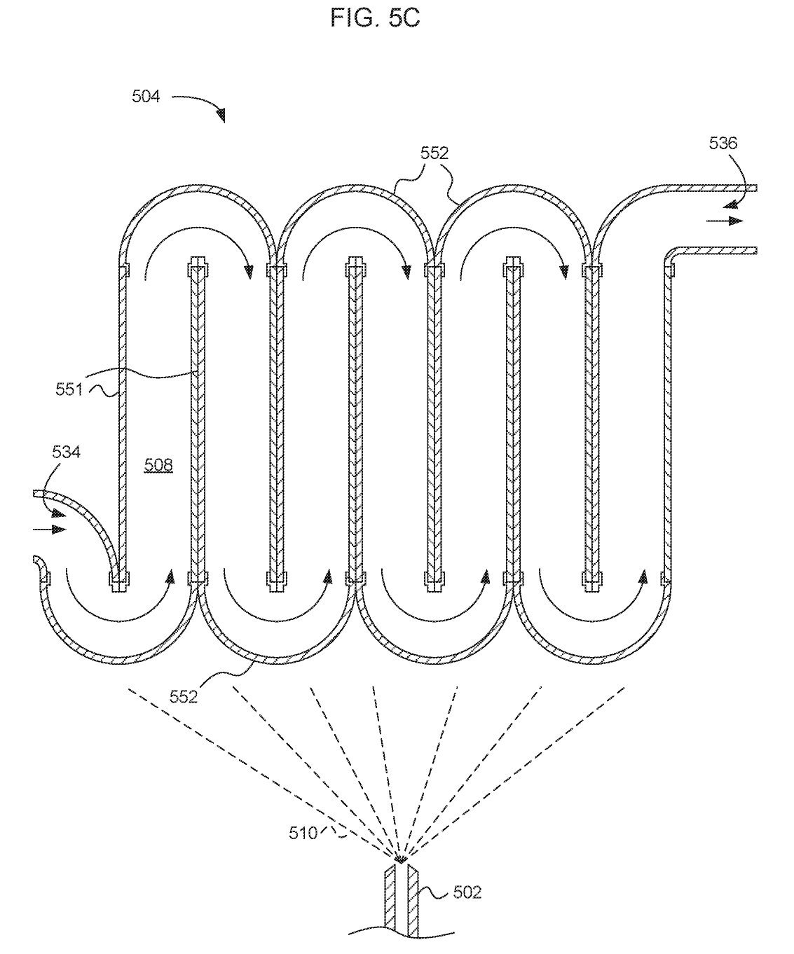

FIG. 5A is a top view of a combustion reaction holder 504, according to one embodiment. The combustion reaction holder 504 includes a plurality of tubes 530 configured to receive a fuel 510 from a fuel nozzle 502 (shown in FIG. 5B) and to substantially contain a combustion reaction 532 (shown in FIG. 5B) of the fuel within the tubes 530. The combustion reaction holder 504 further includes a plurality of fluid holding tubes 551 joined together by U-shaped joints 552 (seen more clearly in FIG. 5C) and configured to hold a working fluid. The U-shaped joints connect the fluid holding tubes 551 into two chains of fuel holding tubes 551. Each chain of fuel holding tubes 551 includes an inlet 534 and an outlet 536. The inlets 534 are configured to receive a working fluid into the fluid holding tubes 551. The outlets 536 are configured to output the working fluid or a product of the working fluid from the fluid holding tubes 551.

The plurality of tubes 530 and the plurality of fluid holding tubes 551 are bundled together closely such that each fluid holding tube 551 is adjacent to multiple tubes 530 contain the combustion reaction. Tubes 530 transfer heat from the combustion reaction to the fluid holding tubes 551. The transfer of heat from the combustion reaction in the tubes 530 to a working fluid in the fluid holding tubes 551 can promote an endothermic reaction of the working fluid in the fluid holding tubes 551. The working fluid, or a product of the working fluid, can be passed from the fluid holding tubes 551 via the outlets 536.

FIG. 5B is a cross-section of the combustion reaction holder 504 taken through a plurality of the tubes 530 of FIG. 5A. The cross-sectional view of FIG. 5B further illustrates a fuel nozzle 502 configured to output fuel 510 into the tubes 530. A combustion reaction 532 of the fuel 510 is contained substantially within the tubes 530. The tubes 530 are configured to transfer heat from the combustion reaction by 32 to the fluid holding tubes 551.

FIG. 5C is a cross-sectional view of the combustion reaction holder 504 taken through a plurality of the fluid holding tubes 551 of FIG. 5A. Each fluid holding tube 551 is coupled to an adjacent fluid holding tube 551 by a U-shaped joint 552. The U-shaped joints 552 join the fluid holding tubes 551 to form a continuous fluid channel from the inlet 534 to the outlet 536.

A working fluid can be input into the fluid holding tubes 551 via the inlet 534. The tubes 530 transfer heat from a combustion reaction within the tubes 530 (see FIGS. 5A and 5B) to the working fluid within the fluid holding tubes 551. In one embodiment, the transfer of heat from the combustion reaction 532 to the working fluid within the fluid holding tubes 551 causes an endothermic reaction of the working fluid. The fluid holding tubes 551 can be packed with discontinuous packing bodies as described previously. The large surface area of the packing bodies can enhance the endothermic reaction of the working fluid within the fluid holding tubes 551. In one embodiment, the combustion reaction holder 504 is a steam methane reformer in which steam and methane are passed into the fluid holding tubes 551 via the inlet 534, hydrogen is produced from an endothermic reaction of the steam and the methane, and the hydrogen is passed from the fluid holding tubes 551 via the outlet 536. Those of skill in the art will recognize, in light of the present disclosure, that the combustion reaction holder 504 can be used in a large variety of applications aside from steam methane reformer. All such other applications fall within the scope of the present disclosure.

In one embodiment, the inlets 534 are connected together as a single inlet into both sets of connected fluid holding tubes 551. Likewise, the outlets 536 can be connected together as a single outlet for both sets of connected fluid holding tubes 551.

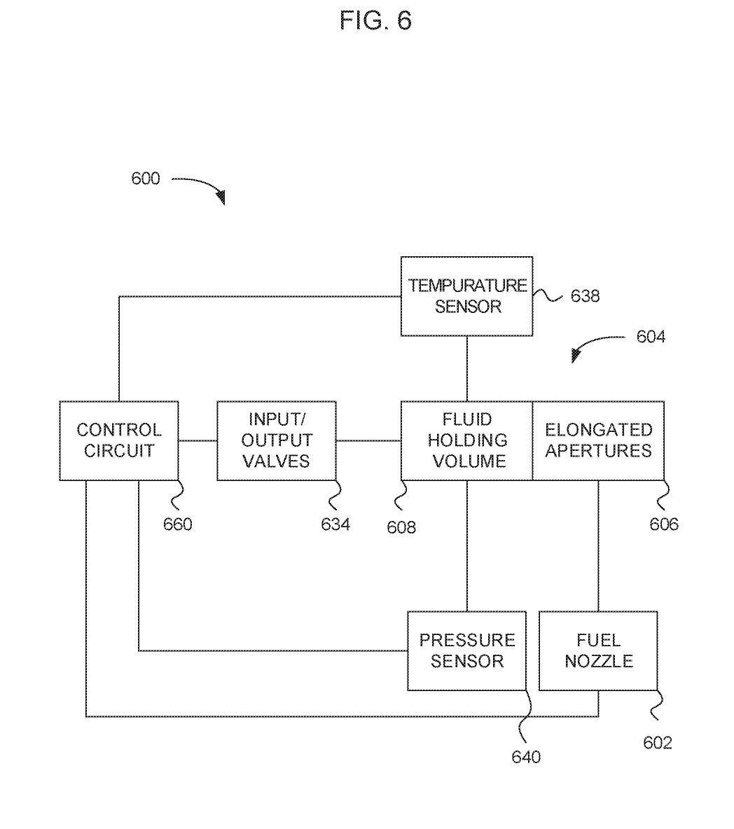

FIG. 6 is a block diagram of a combustion system 600, according to one embodiment. The combustion system 600 includes a fuel nozzle 602 configured to output fuel onto a combustion reaction holder 604. The combustion reaction holder 604 includes a plurality of elongated apertures 606 and a fluid holding volume 608 configured to hold a working fluid. The combustion system 600 further includes input and output valves 634 configured to control the flow of the working fluid to and from the fluid holding volume 608, a temperature sensor 638 and the pressure sensor 640 positioned to measure the temperature and the pressure, respectively, of the working fluid in the fluid holding volume 608, and a control circuit 660. The control circuit 660 is coupled to the temperature sensor 638, the input and output valves 634, the pressure sensor 640, and the fuel nozzle 602.

The fuel from the fuel nozzle 602 is received into the elongated aperture 606. A combustion reaction of the fuel is substantially contained in the elongated aperture 606. Heat generated by the combustion reaction is transferred from the elongated apertures 606 to the working fluid in the fluid holding volume 608.

In one embodiment, the temperature sensor 638 outputs a temperature signal to the control circuit 660. The control circuit 660 can control the fuel nozzle 602 to adjust the outputting of the fuel and/or oxygen/air from the fuel nozzle 602. For example, the control circuit 660 can adjust a distance of the fuel nozzle 602 from the combustion reaction holder 604, a flow rate of the fuel and/or air/oxygen, a concentration of the fuel in a mixture of fuel and oxygen/air, or the velocity of the fuel in order to adjust the amount of heat generated by the combustion reaction within the elongated aperture 606. In this manner, the control circuit 660 can adjust the temperature in the fluid holding volume 608.

In one embodiment, the pressure sensor 640 outputs a pressure signal to the control circuit 660 indicating the pressure in the fluid holding volume 608. The control circuit 660 can adjust the pressure in the fuel holding volume 606 by controlling the input and output valves 634 to adjust the amount of working fluid entering or exiting the fluid holding volume 608. The control circuit can also adjust the pressure by adjusting the heat generated by the combustion reaction as described above.

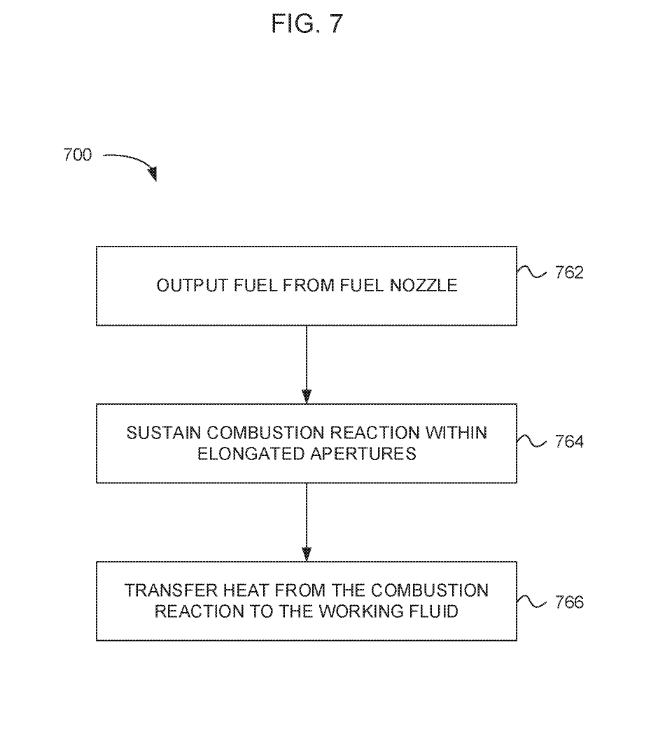

FIG. 7 is a flow diagram of a process 700 for operating a combustion system, according to one embodiment. At 762 a fuel nozzle outputs fuel for a combustion reaction. The fuel nozzle can output fuel or a mixture of fuel and air/oxygen for the combustion reaction. At 764 the fuel from the fuel nozzle is received into elongated apertures of a combustion reaction holder. The elongated apertures substantially contain a combustion reaction of the fuel within the elongated apertures. At 766 heat is transferred from the combustion reaction within the elongated apertures to a working fluid within an interior fluid volume defined by the combustion reaction holder. In one embodiment, the heat transferred from the elongated apertures to the working fluid can promote a reaction of the working fluid to produce a desired product of the working fluid. The product of the working fluid can then be passed from the interior volume.

In one embodiment, the process includes preheating the tubes prior to initiating the combustion reaction within the tubes. This can be accomplished with a preheating mechanism such as a burner configured to sustain a combustion reaction outside but near the combustion reaction holder, thereby heating the tubes to a threshold temperature prior to initiating the combustion reaction fuel within the tubes.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A combustion system, comprising:
a fuel nozzle assembly configured to output fuel and oxidant; and
a combustion reaction holder aligned to receive the fuel and oxidant, the combustion reaction holder including:
a first wall having a plurality of first openings positioned to receive the fuel and oxidant from the fuel nozzle assembly;
a second wall having a plurality of second openings;
a jacket wall operatively coupling the first wall to the second wall; and
a plurality of tubes each extending from a respective first opening to a respective second opening, the plurality of tubes being configured to receive the fuel and oxidant into the tubes via the first openings, to substantially contain a combustion reaction of the fuel and oxidant within the tubes, to transfer heat generated by the combustion reaction to the fluid in the interior volume, and to output flue gas from the tubes via the second openings;
wherein the jacket, the first wall, the second wall, and the plurality of tubes define an interior volume configured to hold a fluid.

2. The system of claim 1, wherein the combustion reaction holder includes an inlet configured to receive the fluid into the interior volume.

3. The system of claim 2, wherein the combustion reaction holder includes an outlet configured to output the fluid or a reaction product of the fluid from the interior volume.

4. The system of claim 3, wherein the combustion reaction holder is configured to receive CH₄ and H₂O as the fluid via the inlet and to output at least H₂ from the outlet.

5. The system of claim 4, wherein the combustion reaction holder is further configured to output CO or CO₂ from the outlet.

6. The system of claim 1, further comprising:
a plurality of packing bodies positioned in the interior volume.

7. The system of claim 6, wherein the packing bodies include are shaped to allow the fluid to pass between the packing bodies.

8. The system of claim 7, wherein the packing bodies include at least one of a ceramic Raschig ring, a ceramic Berl saddle, a ceramic Intalox saddle, and/or a metal ring.

9. The system of claim 3, comprising an inlet valve configured to selectively permit the fluid to enter the inlet.

10. The system of claim 9, comprising an outlet valve configured to selectively permit the fluid or a reaction product of the fluid to exit the outlet.

11. The system of claim 1, comprising a control circuit coupled to the fuel nozzle.

12. The system of claim 11, comprising a temperature sensor positioned in or adjacent to the interior volume and configured to measure a temperature of the fluid and to output a temperature signal to the control circuit.

13. The system of claim 12, wherein the control circuit is configured to adjust an outputting of the fuel from the fuel nozzle assembly based on the temperature signal.

14. The system of claim 11, comprising a pressure sensor positioned in or adjacent to the interior volume and configured to measure a pressure within the interior volume.

15. The system of claim 14, wherein the control circuit is configured to adjust an outputting of fuel from the fuel nozzle assembly based on the pressure signal.

16. The system of claim 11, wherein the control circuit is configured to adjust the outputting of fuel and oxidant from the fuel nozzle assembly based on a condition of the fluid in the interior volume.

17. The system of claim 11, wherein the control circuit is configured to adjust a flow of the fluid into or out of the interior volume based on a condition of the fluid.

18. The system of claim 1, wherein the interior volume is positioned such that the fluid is in direct contact with an outside surface of at least one of the tubes when the fluid is in the interior volume.

19. The system of claim 18, wherein the interior volume is positioned such that the fluid is in direct contact with the outside surface of all of the tubes when the fluid is in the interior volume.

20. The system of claim 1, further comprising a plurality of sheaths each surrounding a respective tube and preventing direct contact between the fluid and the tubes.

21. The system of claim 20, comprising wherein each sheath is separated from the respective tube by a respective gap.

22. The system of claim 1, wherein the tubes are arrayed in groups each having at least one central tube separated from the fluid by a plurality of peripheral tubes in direct contact with each other.

23. The system of claim 22, wherein the peripheral tubes of each group are also in direct contact with the central tube.

24. The system of claim 1, wherein the first wall is integral with the jacket wall.

25. The system of claim 1, wherein the second wall is integral with the jacket wall.

26. The system of claim 1, wherein the first wall, the second wall, and the jacket wall are integral with each other.

27. The system of claim 1, wherein the plurality of tubes are ceramic.

28. The system of claim 1, wherein the plurality of tubes are metal.

29. The system of claim 28, wherein the plurality of tubes are steel.

30. The system of claim 1, wherein the first and second walls are ceramic.

31. The system of claim 1, wherein the jacket wall is ceramic.

32. The system of claim 1, wherein the first wall, the second wall, and the jacket wall are metal.

33. A method comprising:
receiving fuel and oxidant from a fuel nozzle assembly into a plurality of tubes each extending from a respective first opening in a first wall of a combustion reaction holder to a respective second opening in a second wall of the combustion reaction holder;
sustaining a combustion reaction of the fuel and oxidant within the plurality of tubes; and
transferring heat generated by the combustion reaction from the tubes to a fluid in an interior volume of the combustion reaction holder, the interior volume being defined by the first wall, the second wall, a jacket wall operatively coupling the first wall to the second wall, and the plurality of tubes.

34. The method of claim 33, comprising inputting the fluid into the interior volume via an inlet.

35. The method of claim 34, comprising outputting the fluid or a reaction product of the fluid from the interior volume via an outlet.

36. The method of claim 34, comprising controlling an outflow of the fluid or the product of the fluid from the interior volume by an outlet valve coupled to the outlet.

37. The method of claim 33, comprising controlling an inflow of the fluid into the interior volume by an inlet valve coupled to the inlet.

38. The method of claim 33, wherein the fluid includes CH₄ and H₂O.

39. The method of claim 38, wherein transferring heat from the tubes to the fluid generates H₂.

40. The method of claim 33 comprising:
measuring a temperature of the fluid in the interior volume; and
adjusting the outputting of the fuel based on the temperature of the fluid.

41. The method of claim 40, wherein adjusting the outputting of the fuel comprises at least one of adjusting a mixture of the fuel and oxidant, adjusting a flow rate of the fuel, and adjusting a velocity of the fuel.

42. The method of claim 33, comprising:
measuring a pressure within the interior volume; and
adjusting the outputting of the fuel and oxidant based on the pressure of the interior volume.

43. The method of claim 42, wherein adjusting the outputting of the fuel and oxidant comprises at least one of adjusting a mixture of the fuel and oxidant, adjusting a flow rate of the fuel, and adjusting a flow rate of the fuel and the oxidant.

44. A combustion reaction holder comprising:
a casing including a first wall, a second wall, and a jacket wall operatively coupling the first wall to the second wall;
a plurality of first openings in the first wall;
a plurality of second openings in the second wall; and
a plurality of tubes each extending from and contiguous with a respective first opening to and contiguous with a respective second opening, the plurality of tubes being configured to contain a combustion reaction of a fuel and oxidant received into the tubes via the first openings and to transfer heat from the combustion reaction to a fluid positioned in an interior volume defined by the first wall, the second wall, the jacket wall, and the plurality of tubes.

45. The combustion reaction holder of claim 44, comprising an inlet through the jacket wall configured to receive the fluid into the interior volume.

46. The combustion reaction holder of claim 44, comprising a plurality of sheaths each surrounding each respective tube and separating the respective tube from the interior volume.

47. The combustion reaction holder of claim 44, wherein the tubes are arrayed in groups each having at least one central tube separated from the fluid by a plurality of peripheral tubes in direct contact with each other.
